(19) United States
(12) Patent Application Publication
(10) Pub. No.: US 2015/0142988 A1
(43) Pub. Date: May 21, 2015

(54) PROTOCOL STATE BASED PACKET FILTER

(71) Applicant: Gan Wen, Beijing (CN)

(72) Inventor: Gan Wen, Beijing (CN)

(73) Assignee: TELEFONAKTIEBOLAGET L M ERICSSON (PUBL), Stockholm (SE)

(21) Appl. No.: 14/391,513

(22) PCT Filed: Apr. 16, 2012
(86) PCT No.: PCT/CN2012/074070

§ 371 Date: Oct. 9, 2014

(51) Int. Cl. H04L 29/08

(52) U.S. Cl. CPC H04L 69/324
USPC 709/230

(57) ABSTRACT

In a communication protocol wherein state machines maintained by protocol peer nodes transition state only in response to their current state and the state of the peer node, a packet filter engine (33) on a network node (30) is operative to inspect received protocol packets, and filter out redundant packets. The packet filter engine (33) retrieves a current state of a protocol state machine running on a remote node from a protocol packet, and the current state of the local node from a current state table (40). The two states are used to determine the next state of the local node (30). If the current state of the local node (30) and the next state of the local node (30) are the same, the local state machine will not transition states, and the packet is discarded. If the current state of the local node (30) and the next state of the local node (30) are different, the protocol packet is passed to a processor (44) for updating the local state machine and other processing. The processor (44) updates the current state table (40). In this manner, protocol packets including remote node state information, which will not result in a local state transition, are filtered from the processor (44), relieving its computational load.

### TECHNICAL FIELD

The present invention relates generally to communication networks, and in particular to a system and method of efficient handling of protocol packets at a network node.

### BACKGROUND

Data communication networks—whether wired, optical, or wireless networks—are ubiquitous, and a vital part of everyday life in much of the world. A wide variety of communication protocols are known in the art for data routing, network management, failure recovery, and the like. As used herein, a communication protocol is a system of message formats (including syntax and semantics definitions), and rules for exchanging the messages (including synchronization mechanisms), between or among entities in a communication network. Communication protocols may relate to the forwarding of user data through the network, or may relate to network Operations, Administration, and Maintenance (OAM). Examples of well-known communication protocols include Ethernet, Asynchronous Transfer Mode (ATM), Digital Subscriber LineLoop (DSL), Multiprotocol Label Switching (MPLS), Simple Network Management Protocol (SNMP), Telecommunications Management Network (TMN), and many others. Some of these protocols support link failure detection; however, many do not.

Bidirectional Forwarding Detection (BFD) is one protocol that supports fault detection between two forwarding engines (referred to herein generally as network nodes, and with respect to the BFD protocol as protocol peers) connected by a network link, or data transfer path. BFD is a simple protocol that provides link fault detection with low overhead, and operates independently of any higher-level routing or network management protocol that may cover the same nodes and link. BFD is characterized by a simple state machine, maintained independently at each node, and a three-way handshake.

BFD is one representative example of a class of protocols, described more fully herein, that meet the following criteria. First, the protocol state transition (at each node) depends only on the current state of the local state machine, and the current state of the protocol peer, or remote node, state machine. Second, the two protocol peers pass their current state to each other by encapsulating it into protocol packets (or other data unit defined for the particular network, e.g., frame, slot, or the like) and periodically exchanging the protocol packets. Third, the protocol is able to tolerate packet loss. Finally, the protocol includes a recovery mechanism from local conditions—e.g., loss of connectivity, network failure, node reset, or the like—such as resetting the state machine to an initial state.

FIG. 1 is a state diagram of the state machine maintained by each protocol peer in a BFD protocol (the Admin Down state defined by the BFD protocol is omitted here for clarity, but without loss of generality). The state machine comprises three states: DOWN_{local}, INIT_{local}, and UP_{local}. The state machine transitions between states based only on its current state, and the current state communicated by the remote node: DOWNᵣₑₘₒₜₑ, INITᵣₑₘₒₜₑ, and UPᵣₑₘₒₜₑ additional input is a locally-generated Loss Of Connectivity, LOC_{local}, generated for example after a timer expires without having received a protocol packet from the remote node.

The state machine boots up in the DOWN_{local} state, and remains in this state (transmitting its current state to the remote node) so long as the remote node is UPᵣₑₘₒₜₑ or there is a loss of connectivity (LOC_{local}). There are two ways to transition out of DOWN_{local}.

First, if the local node receives an indication that the remote node has also entered the DOWNᵣₑₘₒₜₑ state, it begins the handshake to operational status (UP) by transitioning to the INIT_{local} state, where it remains so long as the remote node remains DOWNᵣₑₘₒₜₑ. When the remote node indicates it is in either the INITᵣₑₘₒₜₑ or UPᵣₑₘₒₜₑ state, the local node transitions to UP_{local} (unless a LOC_{local} sends it to DOWN_{local}).

Alternatively, the remote node may have initiated the transition out of DOWN by itself entering INITᵣₑₘₒₜₑ. If the local node receives this indication in the DOWN_{local} state, it transitions to UP_{local}.

In either case, the local node remains in the UP_{local}, or operational state so long as the remote node is in INITᵣₑₘₒₜₑ or UPᵣₑₘₒₜₑ state. A DOWNᵣₑₘₒₜₑ or LOC_{local} indication will then send the local node back to DOWN_{local}.

Each protocol peer periodically sends a protocol packet to the other, for example, every 3.3 msec. If no protocol packet is received for a predetermined timeout duration, a LOC_{local} signal is generated and the state machine is reset to DOWN_{local}. The protocol packets are typically passed directly to a processor, which maintains the local state machine. This may be due to the complexity of the state transition rules, and/or the need for the protocol to inter-work with other protocols running on the same processor. To manage congestion, most network nodes include some sort of rate limiter that limits, or throttles, the rate at which packets are presented to the processor for processing.

FIG. 2 is a functional block diagram depicting the relevant parts of a typical network node 10 implementing this class of protocol, of which the BFD protocol is one example, with rate limiting. The node 10 includes a receiver 12, packet parser 14, packet filter 16, packet buffer 18, rate limiter 20, switch 22, and processor 24. A receiver 12, such as a network interface in a node of a wired or optical network 10, or a Radio Frequency (RF) transceiver in a node of a wireless network 10, receives a protocol packet. The packet is processed by a packet parser 14, which separates the protocol packets from other packets, such as user traffic, network management overhead, and the like. A packet filter 16 passes protocol packets to a packet buffer 18, or discards them, depending on whether or not the packet buffer 18 is full. A rate limiter 20 controls a switch 22 that selectively pops packets from the buffer 18 into a processor 24 for processing, or holds the packets in the buffer 18. In this manner, the processor 24 is not overwhelmed with protocol packets requiring inspection and processing, at the cost of possible packet loss at the filter 16.

Conventional protocol packet rate limiting, such as that depicted in FIG. 2, suffers several deficiencies. First, since all received protocol packets that are not dropped due to the rate limiting are passed to the processor, the processor receives, and spends cycles processing, a very large load of redundant packets. A remote node may send a protocol packet, e.g., every 3.3 msec. When the link between the nodes is “up” and operational, all of the packets are identical; they all indicate the remote node is in the UPᵣₑₘₒₜₑ state. Hence, the processor is forced to process numerous protocol packets that have no impact on its protocol state machine. Furthermore, the local node may be simultaneously engaged with several different nodes using the same or similar protocols. If packets are dropped due to rate limiting, and without consideration of their source or content, it is likely that many protocol packets indicating a changed remote node state will be dropped, thus increasing the latency of the local node changing state appropriately (and reporting the changed state to the remote node, to allow it to transition its state further).

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure, and is not intended to identify key/critical elements of embodiments of the invention or delineate the scope of the invention. The sole purpose of this summary is to present some concepts disclosed herein in a simplified form as a prelude to the more detailed description that is presented later.

According to one or more embodiments described and claimed herein, a packet filter engine on a network node participating in a communication protocol with a peer node is operative to inspect received protocol packets, and filter out redundant protocol packets. The packet filter engine retrieves a current state of a protocol state machine running on a remote node from a protocol packet, and the current state of the local node from a current state table. Based on the two states, the next state of the local node will be determined. If the local state machine will not transition states, the packet is discarded. Otherwise, the protocol packet is passed to a processor for updating the local state machine and other processing. The processor updates the current state table. In this manner, protocol packets including remote node state information, which will not result in a local state transition, are filtered from the processor, relieving its computational load.

One embodiment relates to a method of filtering protocol packets at a first communication network node participating in a communication protocol with a second node. Both nodes run state machines defined by the same protocol, and the first node protocol state machine transitions in response to its current state and the current state of the second node protocol state machine. A protocol packet is received from the second node. The packet includes an indication of the current state of the second node protocol state machine. The current state of the first node protocol state machine is retrieved. Based on the current state of the first and second node protocol state machines, the next state of the first node protocol state machine is determined. The determined next state is compared with the current state of the first node protocol state machine. If the determined next state differs from the current state, the received protocol packet is passed to a processor at the first node. If the determined next state is the same as the current state, the received protocol packet is discarded.

Another embodiment relates to a method of filtering protocol packets at a first communication network node participating in a communication protocol with a second node. Both nodes run state machines defined by the same protocol. The first node protocol state machine transitions in response to its current state and the current state of the second node protocol state machine. When the state machine on either node transitions to a new state, it remains in the new state until the protocol peer also transitions to the new state. A protocol packet is received from the second node. The packet includes an indication of the current state of the second node protocol state machine. A last known state of the second node protocol state machine is retrieved. The current state is compared with the last known state of the second node protocol state machine. If the current state differs from the last known state, the received protocol packet is passed to a processor at the first node. If the current state is the same as the last known state, the received protocol packet is discarded.

Still another embodiment relates to a first wireless communication network node operative to participate in a communication protocol with a second node. Both nodes run state machines defined by the same protocol. The first node protocol state machine transitions in response to its current state and the current state of the second node protocol state machine. The first node includes memory operative to store the current state of the first node protocol state machine; a processor operative to maintain the first node protocol state machine and to update the memory with the current state of the first node protocol state machine; a packet buffer operative to buffer a protocol packet received from the second node, the protocol packet including the current state of the second node protocol state machine; a state machine predictor operative to compare the current state of the second node protocol state machine and the current state of the first node protocol state machine, and further operative to determine a next state of the first node protocol state machine based on the current state of the second node protocol state machine and the current state of the first node protocol state machine; and a filter operative to pass the received protocol packet to the processor if the determined next state of the first node protocol state machine is different than the current state of the first node protocol state machine, and further operative to discard the received protocol packet if the determined next state of the first node protocol state machine is the same as the current state of the first node protocol state machine.

Yet another embodiment relates to a first wireless communication network node operative to participate in a communication protocol with a second node. Both nodes run state machines defined by the same protocol. The first node protocol state machine transitions in response to its current state and the current state of the second node protocol state machine. When a state machine at either node transitions to a new state, it remains in the new state until the protocol peer also transitions to the new state. The first node includes memory operative to store the current state of the second node protocol state machine; a processor operative to maintain the first node protocol state machine and to update the memory with the current state of the second node protocol state machine; a packet buffer operative to buffer a protocol packet received from the second node, the protocol packet including the current state of the second node protocol state machine; a state comparator operative to compare the current and last known states of the second node protocol state machine; and a filter operative to pass the received protocol packet to the processor if the current and last known states of the second node protocol state machine are different, and further operative to discard the received protocol packet if the current and last known states of the second node protocol state machine are the same.

### BRIEF DESCRIPTION OF THE DRAWINGS

FIG. 1 is a state diagram of a BFD state machine.

FIG. 2 is a functional block diagram of a prior art network node implementing rate limiting.

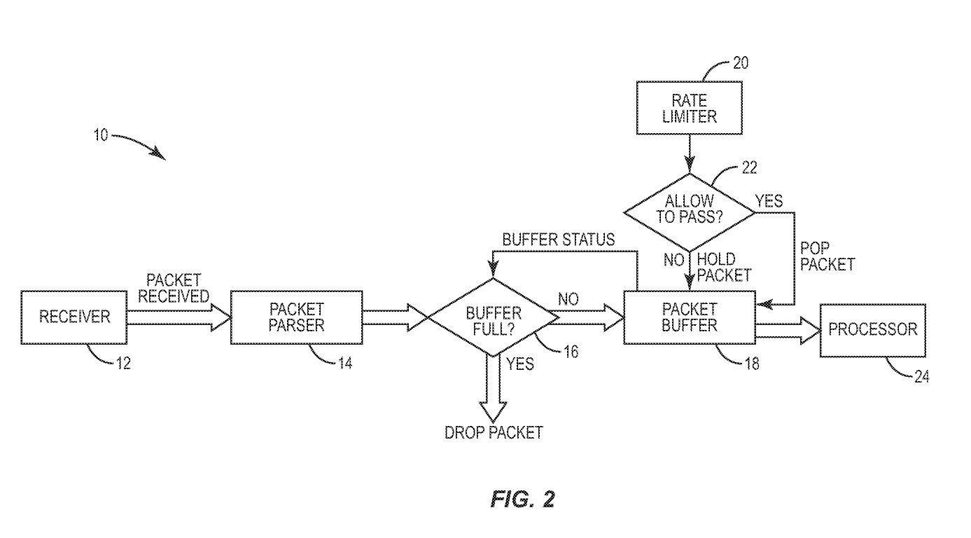

FIG. 3 is a functional block diagram of a network node implementing protocol packet filtering.

FIG. 4 is a flow diagram of a method of filtering protocol packets.

FIG. 5 is a functional block diagram of the network node of FIG. 3.

FIG. 6 is a flow diagram of a method of filtering protocol packets with flow control.

FIG. 7 is a functional block diagram of a network node implementing protocol packet filtering based on remote node state.

FIG. 8 is a flow diagram of a method of filtering protocol packets based on remote node state.

FIG. 9 is a functional block diagram of a network node implementing protocol packet filtering including parameter value filtering.

### DETAILED DESCRIPTION

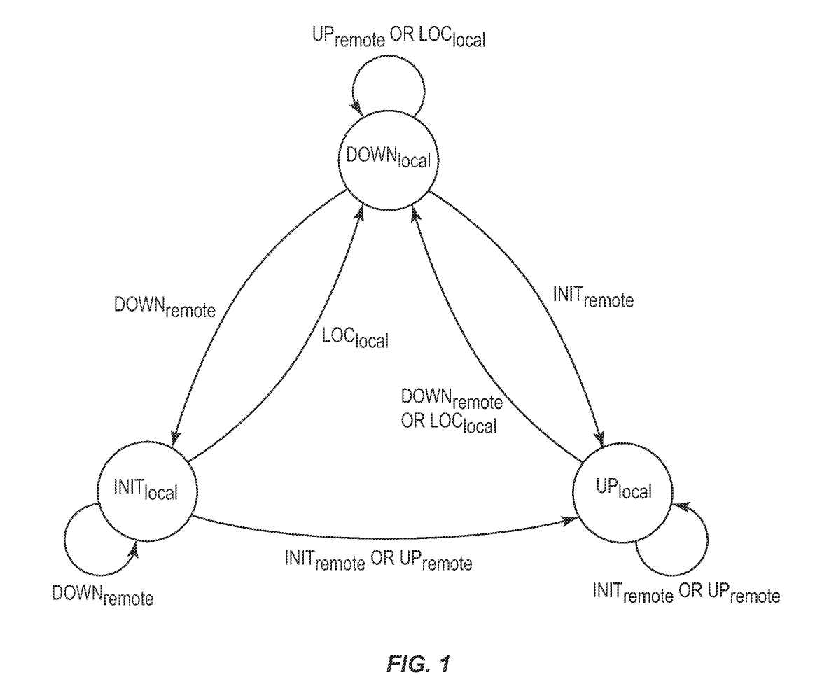

The Bidirectional Forwarding Detection (BFD) protocol described above is one representative example of a class of protocols that satisfy the following conditions. Both protocol peers run state machines defined by the same protocol (see, e.g., FIG. 1). Each protocol state machine transitions state depending on two factors: the current state of the local state machine, and the current state of the remote state machine (not counting transitions to the reset state due to an error or Loss of Connectivity condition). If the protocol peers are denoted A and B, then the protocol state machine operation can be depicted as:

SAₙ₊₁=f(SAₙ,SBₙ) and

SBₙ₊₁=f(SBₙ,SAₙ).

The protocol peers exchange current states via protocol packets (or other mechanism). To tolerate packet loss, the protocol packets are sent periodically or in bursts. State transitions are thus described as:

SAₙ₊₂=f(SAₙ₊₁,SBₙ₊₁)=SAₙ₊₁, if SBₙ₊₁=SBₙ; and

SBₙ₊₂=f(SBₙ₊₁,SAₙ₊₁)=SBₙ₊₁, if SAₙ₊₁=SAₙ.

In other words, if a protocol state machine transits to a new state, it will remain in this new state until the state machine on the protocol peer also transits to a new state. The state evolving rules should hold before the state machine evolves to its steady state.

There are local conditions, for example, the network failure, loss of connectivity, and the like, that may reset a state machine to its initial state, i.e., SA₀ or SB₀.

To synchronize the state machines on the two peers, each state machine should remain in the initial state until the peer state machine also returns to the initial state. Then, the two state machines begin to evolve their states.

As described previously and with reference to FIG. 1, the Bidirectional Forwarding Detection (BFD) protocol is one example of the class of communication protocols described above. However, as described previously, rate limiting at a node may drop protocol packets. Also, sending all protocol packets (that pass the rate limiter) to the processor increases the computational load of the processor when no state transition may be warranted.

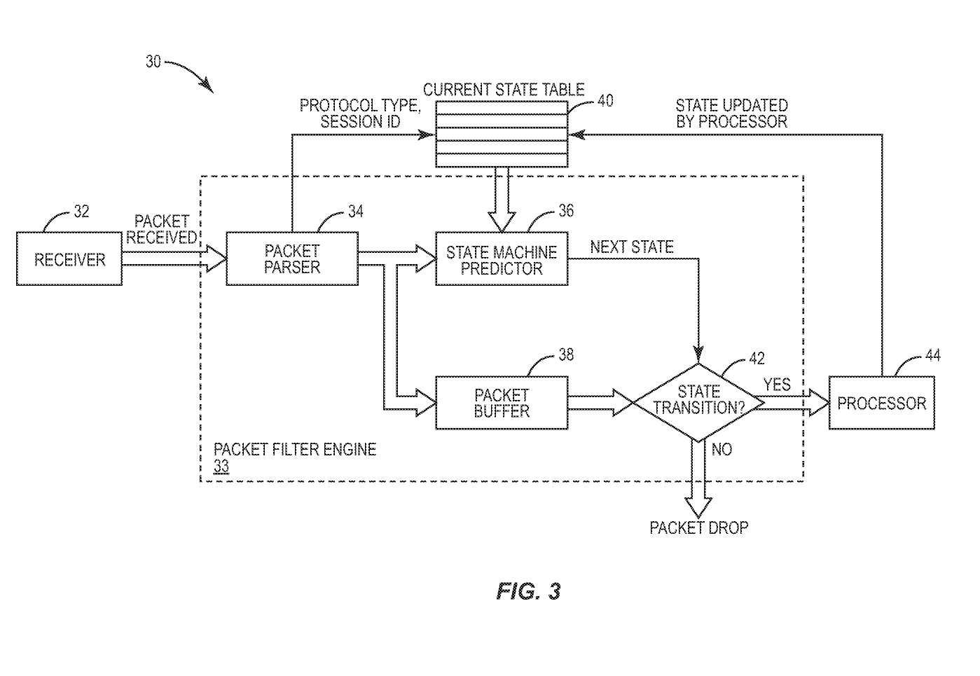

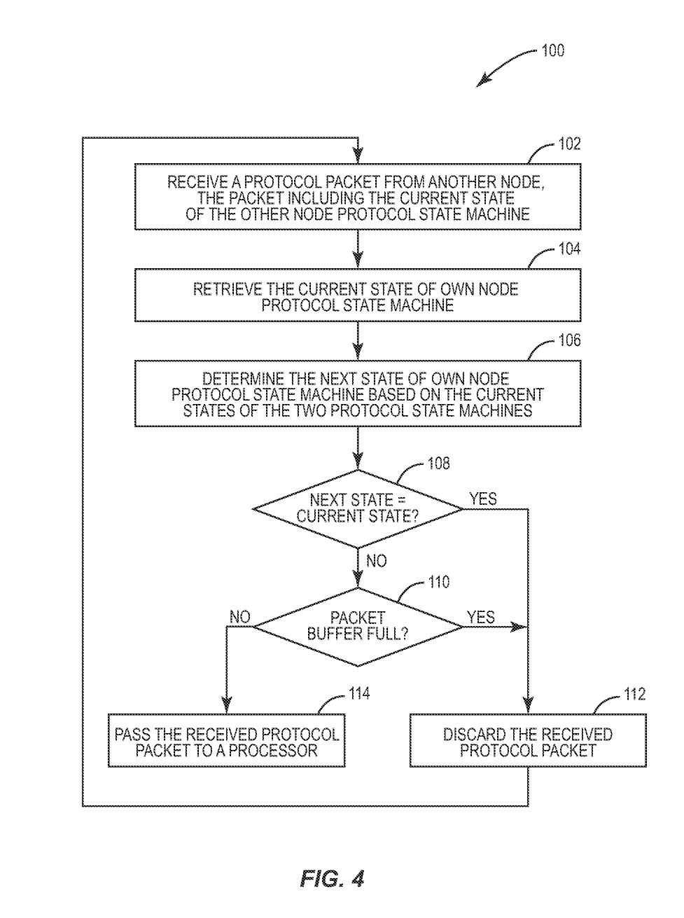

FIG. 3 depicts a receiving portion of a node 30 according to one embodiment of the present invention. The node 30 includes a receiver 32, packet filter engine 33, current state table 40, and processor 44. The packet filter engine 33 includes a packet parser 34, state machine predictor 36, packet buffer 38, and state transition filter 42. FIG. 4 depicts a method 100 of filtering protocol packets at the node 30. A receiver 32, such as a network interface in a node of a wired or optical network 30, or an RF transceiver in a node of a wireless network 30, receives a protocol packet (FIG. 4, block 102). The protocol packet includes the current state of the protocol state machine at a remote node. The received protocol packet is processed by a packet parser 34, which separates the protocol packets from other packets, such as user traffic, network management overhead, and the like. The packet parser 34 also extracts identifying information, such as a protocol type and session ID, from the received packets (e.g., from fields in the packet headers, such as source or destination address, Ethernet type, and the like).

The protocol type and session ID are used to index a current state table 40 (FIG. 4, block 104), which maintains the current states of local protocol state machines, in an embodiment wherein the node 30 is a protocol peer with two or more remote nodes. In an embodiment where the node 30 only engages in a communication protocol (such as BFD) with one other node, the current state table 40 may be replaced with a register or memory location holding the local current state. The current state table 40 (or memory location) is only updated by the processor 44 upon transitioning states in the local protocol state machine.

A state machine predictor 36 extracts the current state of the remote node from a received protocol packet (or receives it from the packet parser 34), and retrieves the current state of the node 30 protocol state machine from the current state table 40. The state machine predictor 36 predicts the next state of the local protocol state machine using the current states of the remote and local nodes.

This prediction drives a packet filter 42. If no local state machine change is predicted (FIG. 4, block 108), the packet filter 42 drops the received protocol packet from the packet buffer 38 (FIG. 4, block 112). On the other hand, if the state machine predictor 36 predicts that the local state machine will change state (FIG. 4, block 108), the protocol packet is retained if there is sufficient buffer space in the packet buffer 38 (FIG. 4, block 110). If not, the protocol packet is discarded (FIG. 4, block 112). If a local state machine transition is predicted, and the packet buffer 38 has room to buffer it, then the protocol packet is passed to the processor 44 (FIG. 4, block 114). The processor 44 maintains the local protocol state machine, and updates the current state table 40 to reflect the new local state.

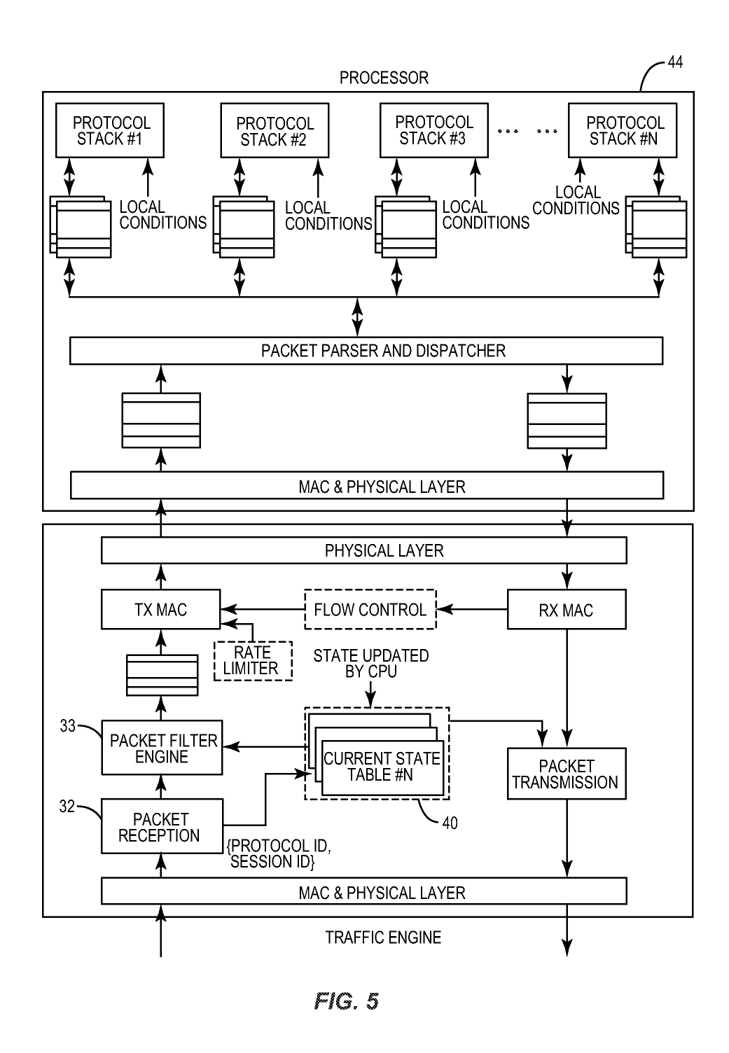

In general, the node 30 may simultaneously be a protocol peer with a plurality of remote nodes. FIG. 5 depicts a different view of the node 30, in which the processor 44 maintains a plurality of protocol stacks 1, 2, 3, . . . , N. When a protocol stack in the processor 44 receives a protocol packet from the packet filter engine 33, it first determines whether the packet will trigger a state transition. If so, a software database is updated, actions corresponding to the state transition are performed (for example, informing inter-working applications of the transition). The processor 44 additionally saves the new local state to the current state table 40, to prevent the packet filter engine 33 from passing more protocol packets to processor 44.

The node 30 periodically sends its local current state (for each instance of the protocol) in a protocol packet to a remote node, e.g., every 3.3 msec. This information will be retrieved from the current state table 40 and provided to a packet transmission engine, as shown.

The node 30 and method 100 described above filter out—and do not pass on to the processor 44—protocol packets that will not trigger a state transition in a local protocol state machine. However, due to the latency between the time the processor 44 receives a packet and the time it configures the latest state, more than one protocol packet may be passed to the processor 44, even though they trigger the same state transition. Hence, the method 100 filters out redundant packets in a steady state, but may still pass redundant packets indicating a change of state.

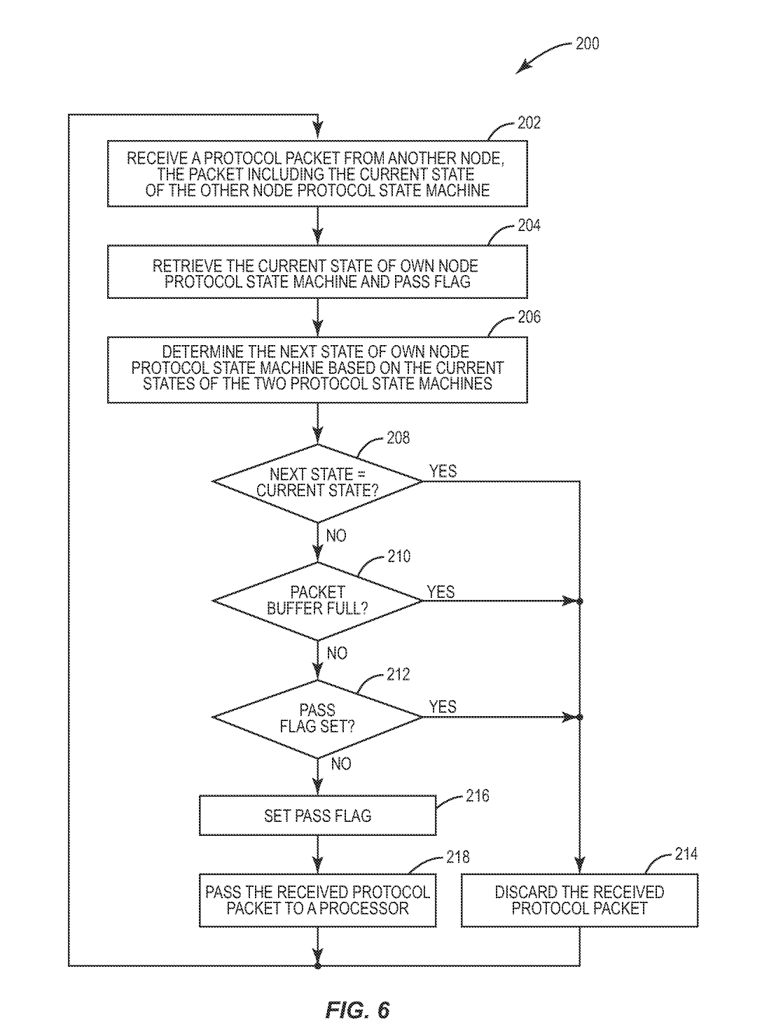

In one embodiment, a method 200, including flow control, is implemented to filter out superfluous protocol packets that indicate a local state machine state change, as depicted in FIG. 6. A protocol packet is received (block 102) by the receiver 32. The protocol packet includes the current state of a remote node protocol state machine. The packet parser obtains the protocol type and session ID, and indexes the current state table 40 to retrieve the current state of the local state machine, and additionally a “pass flag” field (e.g., a bit) that indicates whether the processor 44 has received a protocol packet and is still processing it (block 204). The state machine predictor 36 compares the current states of the local and remote state machines, and determines the next state of the local state machine (block 206).

If the predicted next state of the local state machine is the same as its current state (block 208), the protocol packet is discarded (block 214). If the next state is different, but the packet buffer 38 is full (block 210), the protocol packet is also discarded (block 214). Finally, if the pass flag is set (block 212), then the processor 44 has already received a protocol packet indicating a local state machine transition, and has not completed processing it. In this case, this protocol packet is also discarded (block 214). If none of these conditions is true (blocks 208, 210, 212), then the packet filter engine 33 sets the pass flag in the current state table 40 (block 216), and passes the protocol packet to the processor 44 (block 218). In this manner, only the first protocol packet indicating a local state machine transition is passed to the processor 44, but redundant protocol packets, each indicating the same state of the remote state machine (and hence each indicating the same local state machine transition) are not passed to the processor 44.

Upon processing the received protocol packet and transitioning the local state machine, the processor 44 clears the pass flag from the current state table 40 as it writes the new current state. A newly-received protocol packet will then be passed to the processor 44 only when (1) the current remote state indicates a change in the local state machine, (2) the pass flag is clear, and (3) the packet buffer 38 has enough space to buffer the packet.

In another embodiment, a further optimization depends on the additional condition regarding the communication protocol that when a state machine evolves to a new state, it will remain in this state until the protocol peer also evolves to a new state. When this condition is true, the packet filter engine 33 determines whether to pass a received protocol packet to the processor 44 based on comparing the last known and the current states of the remote node protocol state machine. This embodiment is particularly advantageous when the protocol state machine is complicated, and predicting state machine transitions in the packet filter engine 33 would require significant resources.

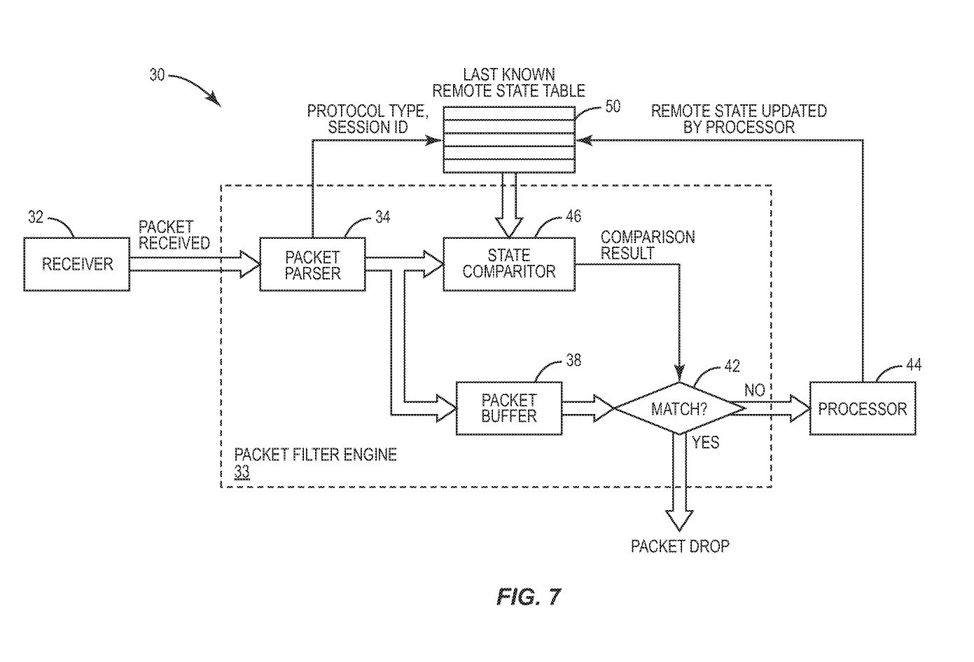

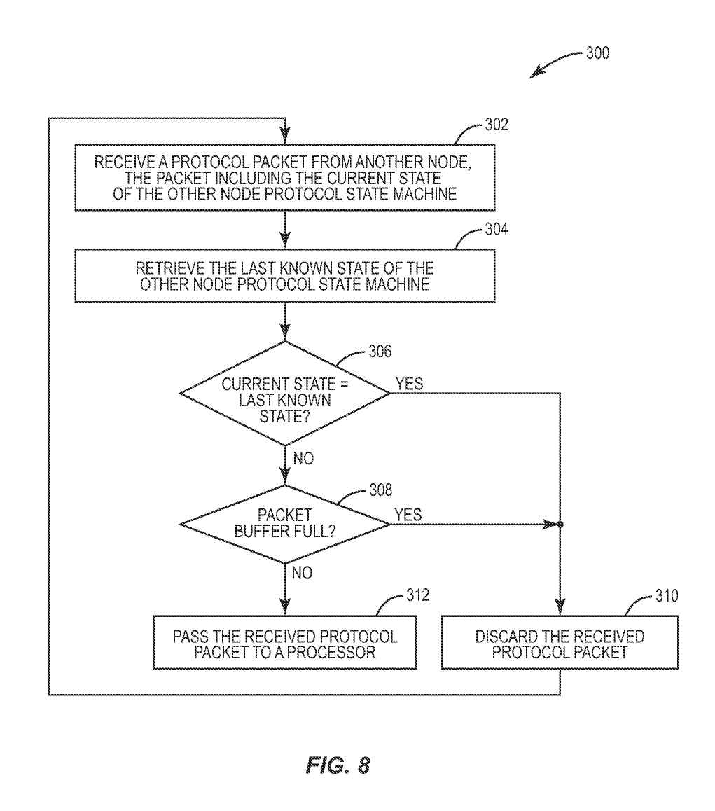

FIG. 7 depicts the node 30 implementing this embodiment of the present invention; a method 300 of filtering packets based on remote state is depicted in FIG. 8. The functional blocks of FIG. 7 that function similarly to those described with reference to FIG. 3 retain that numbering. The differences include a remote state comparator 46 in lieu of the state machine predictor 36, and a last known remote state table 50 in lieu of the current state table 40.

The node 30 according to this embodiment includes a receiver 32, packet filter engine 33, last known remote state table 40, and processor 44. The packet filter engine 33 includes a packet parser 34, remote state comparator 46, packet buffer 38, and state transition filter 42. A receiver 32 receives a protocol packet (FIG. 8, block 302). The protocol packet includes the current state of the protocol state machine at a remote node. The received protocol packet is processed by a packet parser 34, which extracts identifying information, such as a protocol type and session ID, from the received packets.

The protocol type and session ID are used to index a last known remote state table 50 (FIG. 8, block 304), which maintains the last known states of remote protocol state machines. The last known remote state table 50 is only updated by the processor 44 upon transitioning states in the local protocol state machine.

A remote state comparator 46 extracts the current state of the remote node from a received protocol packet (or receives it from the packet parser 34), and compares it to the last known state of the node returned from the last known remote state table 50. If the current state and last known state of the remote node are the same (FIG. 8, block 306), the remote state comparator 46 predicts that the next state of the local protocol state machine will be the same as its current state. Alternatively, if the current state and last known state of the remote node differ (FIG. 8, block 306), the state machine predictor 36 predicts that the next state of the local protocol state machine will change from its current state.

This prediction drives a packet filter 42. If no local state machine change is predicted, the packet filter 42 drops the received protocol packet from the packet buffer 38 (FIG. 8, block 310). On the other hand, if the state machine predictor 36 predicts that the local state machine will change state, the protocol packet is retained if there is sufficient buffer space in the packet buffer 38 (FIG. 8, block 308). If not, the protocol packet is discarded (FIG. 8, block 310). If a local state machine transition is predicted, and the packet buffer 38 has room to buffer it, then the protocol packet is passed to the processor 44 (FIG. 8, block 312). The processor maintains the local protocol state machine, and updates the last known remote state table 50 to reflect the newly discovered remote state.

In some communication protocols of the class considered herein, each participating node is required to “learn” some protocol parameters provided by the peer node. For example, the BFD protocol includes the parameters My Discriminator and Your Discriminator, among others. The My/Your Discriminator parameters are used to demultiplex multiple BFD sessions, or to allow the changing of an IP address on a BFD interface without causing the BFD session to be reset. My Discriminator is a unique, nonzero value generated, e.g., by a local node and transmitted to the remote node. Upon receipt, the remote node associates the My Discriminator value with the peer node, and returns the value as the Your Discriminator parameter as a handshake. If the My Discriminator value is unknown, the remote node returns zero for Your Discriminator. For example, BFD nodes A and B may initially send protocol packets with the following values:

A->B: My Discriminator=1234; Your Discriminator=0

B->A: My Discriminator=4567; Your Discriminator=0

After “learning” the Discriminator values, subsequent packets would include:

A->B: My Discriminator=1234; Your Discriminator=4567

B->A: My Discriminator=4567; Your Discriminator=1234

Once these protocol parameters are learned by a node, protocol packets which do not include new protocol parameter values (or indicate a change in the remote node protocol state machine) are redundant. According to one embodiment of the present invention, the node 30 maintains at least some “learnt” protocol parameters, and filters out protocol packets that do not include new protocol parameter values.

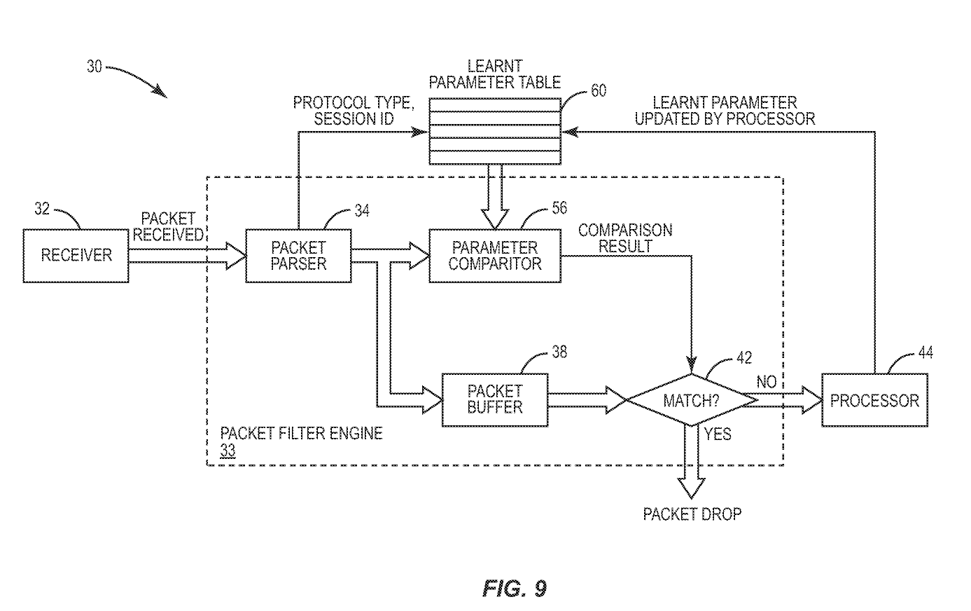

FIG. 9 depicts the node 30 implementing this embodiment of the present invention. The functional blocks of FIG. 9 that function similarly to those described with reference to FIG. 3 retain that numbering. The differences include a parameter comparator 56 in lieu of the state machine predictor 36, and a learnt parameter table 60 in lieu of the current state table 40.

The node 30 according to this embodiment includes a receiver 32, packet filter engine 33, learnt parameter table 60, and processor 44. The packet filter engine 33 includes a packet parser 34, parameter comparator 56, packet buffer 38, and state transition filter 42. A receiver 32 receives a protocol packet. The protocol packet includes the current state of the protocol state machine at a remote node and the current value of at least one protocol parameter. The received protocol packet is processed by a packet parser 34, which extracts identifying information, such as a protocol type and session ID, from the received packets.

The protocol type and session ID are used to index a learnt parameter table 60, which maintains the last known values of remote node protocol parameters. The learnt parameter table 60 is only updated by the processor 44 upon processing updated parameter values received from a remote node.

A parameter comparator 46 extracts the current value of a remote node protocol parameter from a received protocol packet (or receives it from the packet parser 34), and compares it to the learned value of the parameter returned from the learnt parameter table 60. If the current value and the learned value of the remote node parameter are the same, the parameter comparator 46 indicates to the packet filter 42 that the protocol packet should be dropped. On the other hand, if the current value and the learned value of the remote node parameter differ, the packet filter 42 passes the protocol packet to the processor 44. The processor processes the new parameter value, and updates the learnt parameter table 60 to reflect the new remote node protocol parameter value. In this manner, only protocol packets indicating updated parameter values (or a changed remote state) are passed to the processor 44.

Although described herein with reference to the BFD protocol, the present invention is not so limited, and is in fact applicable to any communication protocol of the class described herein (complementary state machines transition state in response only to the current state of the local and remote state machines, the protocol peers exchange states periodically, and the protocol includes a recovery mechanism and hence is tolerant of packet loss). Those of skill in the art will readily recognize that various embodiments of the present invention have been described separately and independently herein for clarity of understanding. In practice, features of the various embodiments may be combined in appropriate implementations, as may be readily determined by those of skill in the art without undue experimentation, given the teachings of the present disclosure.

The processor 44 may comprise any sequential state machine operative to execute machine instructions stored as machine-readable computer programs in memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

The current state table 40, last known remote state table 50, and learnt parameter table 60 are preferably implemented in machine-readable memory. Those of skill in the art also readily recognize that memory is necessary for operation of the processor 44. Such memory may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like.

Those of skill in the art will recognize that some or all of functional blocks depicted in the Figures and described herein, such as any or all of the receiver 32, packet parser 34, state machine predictor 36, remote state comparator 46, parameter comparator 46, packet buffer 38, and state transition filter 42, may be implemented in hardware, programmable logic together with appropriate firmware, or as software modules executable on the processor 44 or other computational device.

As used herein, the term “protocol state machine,” or simply “state machine” (and as qualified by the terms “local” and “remote”) refers to an abstract, finite state machine model defined by a communication protocol and maintained at each of peer network nodes participating in the communication protocol. The term local or remote state refers to the current state of the protocol state machine maintained on the local or remote node, respectively. The term “protocol parameter” or simply “parameter” refers to a parameter defined by and operative within a communication protocol. As an example, the BFD parameters My Discriminator and Your Discriminator are protocol parameters.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of filtering protocol packets at a first communication network node participating in a communication protocol with a second node, wherein both nodes run state machines defined by the same protocol and wherein the first node protocol state machine transitions in response to its current state and the current state of the second node protocol state machine, the method comprising:
receiving a protocol packet from the second node, the packet including an indication of the current state of the second node protocol state machine;
retrieving the current state of the first node protocol state machine;
determining, based on the current state of the first and second node protocol state machines, the next state of the first node protocol state machine;
comparing the determined next state with the current state of the first node protocol state machine; and
if the determined next state differs from the current state, passing the received protocol packet to a processor at the first node; and
if the determined next state is the same as the current state, discarding the received protocol packet.

2. The method of claim 1, further comprising
determining a protocol type and session ID associated with the received protocol packet; and
wherein retrieving the current state of the first node protocol state machine comprises indexing a current state table using the protocol type and session ID to obtain the current state of the first node protocol state machine.

3. The method of claim 1, further comprising periodically sending a protocol packet to the second node, the sent protocol packet including at least an indication of the current state of the first node protocol state machine.

4. The method of claim 1, further comprising:
setting a pass flag upon passing a first received protocol packet to the processor at the first node; and
discarding subsequent received protocol packets if the pass flag is set.

5. The method of claim 1, wherein the communication protocol comprises a Bidirectional Forwarding Detection, BFD, protocol.

6. The method of claim 5, further comprising:
receiving a protocol packet from the second node, the packet including a current value of a parameter associated with the second node;
retrieving a last known value of the parameter;
comparing the last known value of the parameter with the current value of the parameter; and
if the current value differs from the last known value, passing the received protocol packet to a processor at the first node; and
if the current value is the same as the last known value, discarding the received protocol packet.

7. The method of claim 6, further comprising:
determining a protocol type and session ID associated with the received protocol packet; and
wherein retrieving the last known value of the parameter comprises indexing a learnt parameter table using the protocol type and session ID to obtain the last known value of the parameter.

8. The method of claim 6, wherein the parameter is the BFD My Discriminator parameter.

9. The method of claim 7, further comprising periodically sending a protocol packet to the second node, the sent protocol packet including at least the last known value of the My Discriminator parameter to the second node as a Your Discriminator parameter.

10. A method of filtering protocol packets at a first communication network node participating in a communication protocol with a second node, wherein both nodes run state machines defined by the same protocol, wherein the first node protocol state machine transitions in response to its current state and the current state of the second node protocol state machine, and wherein when the state machine on either node transitions to a new state, it remains in the new state until the protocol peer also transitions to the new state, the method comprising:
receiving a protocol packet from the second node, the packet including an indication of the current state of the second node protocol state machine;
retrieving a last known state of the second node protocol state machine;
comparing the current state with the last known state of the second node protocol state machine; and
if the current state differs from the last known state, passing the received protocol packet to a processor at the first node; and
if the current state is the same as the last known state, discarding the received protocol packet.

11. The method of claim 10, further comprising:
determining a protocol type and session ID associated with the received protocol packet; and
wherein retrieving the last known state of the protocol state machine at the second node comprises indexing a last known remote state table using the protocol type and session ID to obtain the last known state of the protocol state machine at the second node.

12. A first wireless communication network node operative to participate in a communication protocol with a second node, wherein both nodes run state machines defined by the same protocol and wherein the first node protocol state machine transitions in response to its current state and the current state of the second node protocol state machine, the first node comprising:
memory operative to store the current state of the first node protocol state machine;
a processor operative to maintain the first node protocol state machine and to update the memory with the current state of the first node protocol state machine;
a packet buffer operative to buffer a protocol packet received from the second node, the protocol packet including the current state of the second node protocol state machine;
a state machine predictor operative to compare the current state of the second node protocol state machine and the current state of the first node protocol state machine, and further operative to determine a next state of the first node protocol state machine based on the current state of the second node protocol state machine and the current state of the first node protocol state machine; and
a filter operative to pass the received protocol packet to the processor if the determined next state of the first node protocol state machine is different than the current state of the first node protocol state machine, and further operative to discard the received protocol packet if the determined next state of the first node protocol state machine is the same as the current state of the first node protocol state machine.

13. The node of claim 12, wherein the memory comprises a state table operative to store the current state of a plurality of first node protocol state machines, each first node protocol state machine associated with a different instance of the communication protocol, the state table indexed by protocol type and session ID parameters, and further comprising:
a packet parser operative to
inspect received protocol packets;
index the state table with protocol type and session ID parameters associated with the protocol packets; and
extract from the protocol packets and pass to the state machine predictor, the current state of a protocol state machine at a different node.

14. The node of claim 13, wherein the processor is further operative to periodically send a protocol packet to the second node, the sent protocol packet including at least an indication of the current state of the first node protocol state machine.

15. The node of claim 13, wherein
the processor is further operative to
set a pass flag in the memory upon receiving a protocol packet from the filter; and
clear the pass flag in the memory upon updating the memory with a new current state for the first node protocol state machine; and
the filter is further operative to discard received protocol packets if the pass flag is set.

16. The node of claim 13, wherein the communication protocol comprises a Bidirectional Forwarding Detection, BFD, protocol.

17. The node of claim 16, further comprising a parameter comparator (56) operative to compare a current state of a parameter associated with the second node protocol state machine, the current state of the parameter included in a received protocol packet, with the last known value of the parameter; and
wherein the processor is further operative to update the memory to store the last known value of the parameter; and
wherein the filter is further operative to pass the received protocol packet to the processor if the current state of the parameter is different than the last known state of the parameter, and to discard the received protocol packet if the current state of the parameter is the same as the last known state of the parameter.

18. The node of claim 17, wherein the memory comprises a learnt parameter table operative to store the last known value of a plurality of parameters, each associated with a different instance of the communication protocol, the learnt parameter table indexed by protocol type and session ID parameters, and further comprising:
a packet parser operative to
inspect received protocol packets;
index the learnt parameter table with protocol type and session ID parameters associated with the protocol packets; and
extract from the protocol packets and pass to the parameter comparator, the current state of a parameter associated with a protocol state machine at a different node.

19. The node of claim 18, wherein the parameter is the BFD My Discriminator parameter.

20. The node of claim 19, wherein the processor is further operative to periodically send a protocol packet to the second node, the sent protocol packet including at least the last known value of the My Discriminator parameter to the second node as a Your Discriminator parameter.

21. A first wireless communication network node operative to participate in a communication protocol with a second node, wherein both nodes run state machines defined by the same protocol, wherein the first node protocol state machine transitions in response to its current state and the current state of the second node protocol state machine, and wherein when a state machine at either node transitions to a new state, it remains in the new state until the protocol peer also transitions to the new state, the first node comprising:
memory operative to store the last known state of the second node protocol state machine;
a processor operative to maintain the first node protocol state machine and to update the memory with the current state of the second node protocol state machine;
a packet buffer operative to buffer a protocol packet received from the second node, the protocol packet including the current state of the second node protocol state machine;
a state comparator operative to compare the current and last known states of the second node protocol state machine; and
a filter operative to pass the received protocol packet to the processor if the current and last known states of the second node protocol state machine are different, and further operative to discard the received protocol packet if the current and last known states of the second node protocol state machine are the same.

22. The node of claim 21, wherein the memory comprises a last known remote state table operative to store the last known state of a plurality of other node protocol state machines, the last known remote state table indexed by protocol type and session ID parameters, and further comprising:
a packet parser operative to
inspect received protocol packets;
index the remote state table with protocol type and session ID parameters associated with the protocol packets; and
extract from the protocol packets and pass to the state comparator, the current state of a protocol state machine at a different node.

23. The node of claim 22, wherein the processor is further operative to update the last known remote state table.
